(19) United States
(12) Patent Application Publication
(10) Pub. No.: US 2026/0156138 A1
(43) Pub. Date: Jun. 4, 2026

(54) AUTONOMOUS GENERATIVE PRE-TRAINED AI DRIVEN PURPLE TEAMING SOLUTION FOR SIMULATING ADVANCED PERSISTENT THREATS AND GENERATING TAILORED RISK REMEDIATION

(71) Applicant: PLURILOCK SECURITY SOLUTIONS INC., Victoria (CA)

(72) Inventors: Ian PATERSON, Victoria (CA); Youssef NAKKABI, Victoria (CA); Christian SCOTT, New Braunfels, TX (US)

(21) Appl. No.: 19/408,573

(22) Filed: Dec. 4, 2025

Related U.S. Application Data
(60) Provisional application No. 63/727,738, filed on Dec. 4, 2024.

(51) Int. Cl. H04L 9/40

(52) U.S. Cl. CPC H04L 63/1433

(57) ABSTRACT

Devices, systems, and methods for AI-driven security exercises emulate evolving threats across varied environments to proactively assess and strengthen resilience. AI models fuse external knowledge and best practices to design safe, multi-step simulations orchestrated by lightweight agents that elicit realistic, non-disruptive defensive behavior. The platform ingests operational signals and environment descriptions to adapt scenarios in a vendor-agnostic, environment-aware way. Iterative campaigns expand coverage and translate outcomes into qualitative likelihood and impact indicators for comparative risk views by asset and service. The system outputs machine-readable guidance summarizing effective and ineffective defenses, mapping findings to simulated paths, and recommending prioritized improvements across key control domains, aligned to governance and assurance expectations. By uniting adaptive simulation, continuous context, and outcome-driven guidance, the invention exposes material risk, focuses remediation on highest-value areas, and demonstrates measurable improvement over time.

### CROSS-REFERENCE TO RELATED APPLICATIONS

This patent application claims the benefit of U.S. Provisional Application No. 63/727,738 filed on December 4, 2024, entitled AN AUTONOMOUS GENERATIVE PRE-TRAINED AI DRIVEN PURPLE TEAMING SOLUTION FOR SIMULATING ADVANCED PERSISTENT THREATS AND GENERATING TAILORED RISK REMEDIATION, which is incorporated herein by this reference in its entirety.

### TECHNICAL FIELD

The present disclosure generally relates to systems and methods for evaluating, testing, and improving security of computing environments.

### BACKGROUND

Organizations operating modern information technology (IT) and operational technology (OT) systems face increasingly sophisticated cyber threats that are often carried out by advanced persistent threat (APT) actors. Traditional security testing tools may provide limited or static simulations, requiring manual setup and lacking the ability to incorporate real-time threat-intelligence data or adapt to changing conditions within an organization’s environment. As a result, security teams may struggle to identify evasive attack paths, understand how their defenses respond to realistic adversarial behaviors, or generate actionable remediation guidance.

### SUMMARY

Various implementations disclosed herein include systems, devices, and methods for performing autonomous purple teaming using generative artificial intelligence. In some implementations, the system employs a generative model configured to simulate adversarial behavior across information technology (IT) and operational technology (OT) environments. The generative model may dynamically select, evolve, and contextualize attack paths using retrieval-augmented generation (RAG), enabling simulations that adapt to an organization’s architecture, assets, and security posture. By automatically generating and executing realistic attack scenarios, the system improves the accuracy, efficiency, and scalability of threat-simulation processes.

In some implementations, the system may receive optional inputs from security-monitoring platforms, such as Security Information and Event Management (SIEM), Endpoint Detection and Response (EDR), Extended Detection and Response (XDR), or other telemetry sources. These inputs may be used to track red-team actions and blue-team responses in real time, refine adversarial decision-making, and provide opportunities to generate progressively evasive attack paths or kill-chain variants. By incorporating real-time data, the system may continuously optimize its simulations to more closely mirror emerging threat behaviors and environmental changes within an organization.

In some implementations, the system may integrate established offensive-security frameworks, including the Penetration Testing Execution Standard (PTES), Open Worldwide Application Security Project (OWASP) Web Top Ten, and MITRE Adversarial Tactics, Techniques, and Common Knowledge (MITRE ATT&CK), as inputs to the generative and RAG models. These frameworks may be used to guide the selection of tactics, techniques, and procedures (TTPs) across multiple stages of the attack lifecycle, ensuring that generated scenarios remain realistic, comprehensive, and aligned with industry standards.

In some implementations, the system may deploy endpoint agents and network agents configured to execute simulated attack activities, including reconnaissance, exploitation, evasion, lateral movement, privilege escalation, and data exfiltration. The agents may operate within controlled environments to validate the feasibility of generated attack paths and to measure defensive responses. Such hybrid execution, combining generative simulation with live validation, enhances both the accuracy of risk assessments and the fidelity of training environments for defenders.

In some implementations, the system may generate tailored risk-remediation recommendations using generative models informed by organizational asset inventories, environmental context, and outputs of security-monitoring platforms. These recommendations may include prioritized mitigation steps, defensive-control adjustments, and compliance insights aligned with industry standards or regulatory frameworks. By automating the synthesis of risk intelligence and remediation guidance, the system supports faster and more informed decision-making by security teams.

In some implementations, the system may compute compliance assessments and breach-cost estimates associated with simulated kill chains. For example, the system may evaluate how executed attack stages implicate compliance obligations under cybersecurity frameworks or assess potential financial impact under hypothetical compromise scenarios. Such evaluations may support strategic risk management by quantifying security posture in operational and economic terms.

Across the foregoing implementations, the system may continuously improve its performance using feedback loops driven by threat-intelligence updates, real-world network telemetry, and model-performance metrics. These adaptive capabilities enable the system to provide increasingly accurate simulations, refined remediation guidance, and enhanced support for organizational risk management and compliance adherence.

In general, one innovative aspect of the subject matter described in this specification can be embodied in methods that autonomously evaluate security weaknesses in computing environments by simulating adversarial behaviors that mimic real-world cyber attackers. In some implementations, the methods employ an artificial intelligence (AI) model to generate simulated attack activities informed by one or more offensive-security frameworks, including the Penetration Testing Execution Standard (PTES), the Open Worldwide Application Security Project (OWASP) Top Ten, and the MITRE Adversarial Tactics, Techniques, and Common Knowledge (ATT&CK) framework. The AI model can generate sequences of tactics, techniques, and procedures (TTPs) representative of those used by advanced persistent threats (APTs), enabling the creation of realistic, context-aware attack paths tailored to a particular organization’s environment.

These and other implementations may each optionally include one or more of the following features.

In some implementations, software agents may be deployed to validate and execute simulated attack activities. For example, endpoint agents may operate on endpoint devices such as servers, workstations, or mobile devices, while network agents may operate on switches, routers, gateways, or other infrastructure components. These agents may perform activities associated with various stages of an attack lifecycle, including reconnaissance, exploitation, lateral movement, evasion, privilege escalation, and exfiltration, within information technology (IT) or operational technology (OT) environments. Such execution enables realistic yet non-destructive emulation of cyberattacks, supporting more accurate security assessments and controlled validation of defensive controls.

In some implementations, contextual information may be obtained from the computing environment during or after execution of the simulated activities. This contextual information may include telemetry from Security Information and Event Management platforms (SIEM), Endpoint Detection and Response systems (EDR), Extended Detection and Response systems (XDR), defensive actions taken by security controls, or topology data describing the organization’s network structure. The system may use a retrieval-augmented generation technique (RAG) to analyze this contextual information and adapt the simulated attack activities accordingly. By selecting or modifying TTPs based on real-time inputs, the system can generate more evasive attack paths, update simulations to reflect threat-intelligence indicators such as indicators of attack (IoAs) or indicators of compromise (IoCs), and more accurately model the behavior of sophisticated APT actors.

In some implementations, adapted simulations may be repeatedly deployed to expand coverage across assets, services, network segments, or attack vectors. The system may execute multiple iterations in a feedback loop that continuously refines attack behaviors based on updated contextual data. These iterative evaluations may allow the system to surface weaknesses that traditional red-team or penetration-testing approaches might overlook, including vulnerabilities that appear only under specific environmental, architectural, or defensive conditions. The system may also calculate a hypothetical breach cost based on affected assets and assign risk scores that quantify potential business impact.

In some implementations, the system may generate tailored remediation actions in response to the outcomes of the simulated and adapted activities. Such remediation actions may include configuration updates for network security controls, changes to policies for Identity and Access Management (IAM) systems, adjustments to endpoint security agents, or recommended modifications to cloud infrastructure configurations. The system may further map discovered weaknesses to relevant compliance requirements and generate machine-readable reports that depict attack paths, defensive breakdowns, and prioritized remediation steps. By autonomously evaluating the environment, adapting simulations based on real-time context, and producing actionable, compliance-aware remediation insights, the system enables organizations to proactively strengthen their security posture against advanced cybersecurity threats.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an example arrangement in which a system produces simulated adversarial behaviors and deploys agents within a computing environment to access system response, in accordance with some implementation.

FIG. 2 illustrates an example process flow in which simulated activities are executed within a computing environment and corresponding system responses are collected for analysis, in accordance with some implementations.

FIG. 3 illustrates an example process in which information obtained from a computing environment is used to generate updated activities for subsequent execution within that environment, in accordance with some implementations.

FIG. 4 illustrates an example flow diagram of a process for generating and performing simulated activities within a computing environment and producing corresponding system outputs.

FIG. 5 illustrates an example block diagram of an electronic device configured for autonomous AI-driven cybersecurity simulation and risk management, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

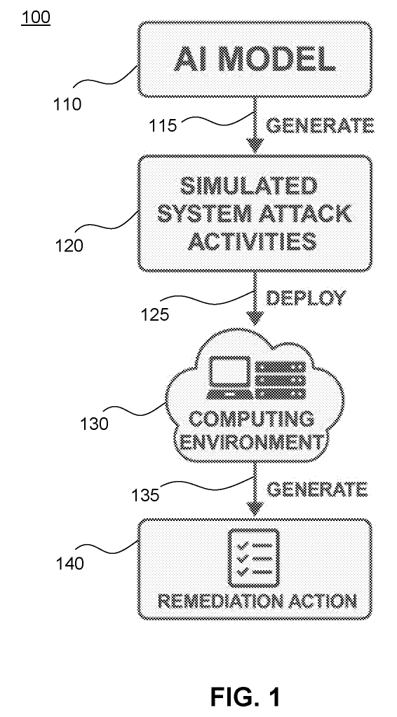

FIG. 1 illustrates an example system 100 for autonomously generating simulated system attack activities, executing those activities within a computing environment, and producing corresponding remediation actions. The system 100 may include an AI model 110, a simulated system attack activities module 120, a computing environment 130, and a remediation action module 140, which may interact in a sequential workflow to evaluate security weaknesses and generate corrective measures.

The AI model 110 may represent one or more artificial intelligence components configured to generate simulated adversarial behaviors. The AI model 110 may include a generative pre-trained model or other machine-learning mechanisms trained on cybersecurity frameworks, offensive-security techniques, or threat-intelligence data. As indicated by an arrow 115, the AI model 110 outputs or generates simulated system attack activities based on input parameters, such as known tactics, techniques, and procedures (TTPs) associated with real-world cyber threats.

In another implementation, the AI model 110 may be implemented as a reinforcement-learning (RL) agent that improves its adversarial behavior generation through continuous interaction with simulated network environments. The RL-based AI model 110 may be trained to maximize an objective function representing attack progress, stealthiness, evasion, or privilege escalation success. The model is exposed to many (e.g., thousands) of simulated environments representing various enterprise architectures, and it learns to adaptively select next-step adversarial actions such as credential harvesting, command-and-control communication, or privilege escalation. As indicated by the arrow 115, the trained RL model outputs context-aware attack sequences tuned to the provided input parameters, including the organization’s endpoint configurations, known vulnerabilities, or blue-team detection strengths.

In yet another implementation, the AI model 110 may include a hybrid symbolic-neural reasoning system that combines knowledge-graph inference with neural pattern recognition. The model may maintain a structured graph encoding relationships between tactics, techniques, procedures, vulnerabilities, and environmental conditions. Neural embeddings derived from cybersecurity training data are linked to symbolic reasoning rules so that the AI model 110 can infer probable adversarial steps even when data is incomplete or ambiguous. The model evaluates input conditions, such as vulnerability scores or target system topology, and outputs simulated adversarial paths that reflect both deterministic rule-based reasoning and probabilistic neural inference. An arrow 115 illustrates that these inferred attack paths are then transmitted to downstream components for execution.

In another variant, the AI model 110 may be implemented as a retrieval-augmented large language model specialized in cybersecurity threat generation. The model incorporates external threat intelligence databases and offensive-security documentation as part of its retrieval layer. Upon receiving input parameters such as “simulate an Advanced Persistent Treat (APT)-style spear phishing compromise” or “generate evasion strategies for specific Endpoint Detection and Response (EDR) configurations,” the retrieval module fetches relevant technical data, which the Large Language Model (LLM) integrates into a cohesive simulated attack narrative. The arrow 115 indicates that the LLM produces multi-stage attack sequences consistent with the most recent threat-intelligence data, ensuring that the generated adversarial behavior aligns with evolving real-world Tactics, Techniques, and Procedures (TTPs).

In further implementation, the AI model 110 may utilize a diffusion-model architecture adapted for cybersecurity behavior synthesis. Rather than generating images, the diffusion model gradually refines noisy initial threat patterns into coherent attack-step sequences. The model is trained using time-indexed adversarial behavior datasets so that it learns the probabilistic distribution of attack evolution over time. Based on input factors such as threat actor profile, target operating system, or defensive posture, the diffusion model produces detailed sequences of adversarial actions including reconnaissance queries, exploit payload selection, and privilege-escalation chains, as represented by arrow 115.

In additional implementation, the AI model 110 may be configured as a multi-agent ensemble system in which several specialized sub-models collaborate to generate realistic adversarial behavior. One sub-model may emulate initial access vectors, another may focus on privilege escalation, while another may specialize in detection evasion. The AI model 110 orchestrates the sub-models through a coordination engine that evaluates environmental inputs and determines the optimal attack sequence across the combined agents. The arrow 115 indicates that the ensemble’s coordinated output forms a comprehensive adversarial behavior simulation tailored to the environment.

The generated attack activities are provided to the simulated system attack activities module 120, which represents a stage at which the simulated adversarial behaviors are prepared for deployment. In some implementations, the module 120 may define sequences of reconnaissance steps, exploitation attempts, lateral-movement patterns, privilege-escalation actions, or other cybersecurity attack stages. These activities are then deployed, as shown by an arrow 125, to one or more software agents configured to execute them.

The software agents perform the activities within the computing environment 130, which may include physical devices, virtual machines, cloud infrastructure, networks, storage systems, endpoint devices, or any combination thereof. As depicted by the cloud-shaped icon, the computing environment 130 represents the target context in which the simulated attacks are run. During execution, the computing environment 130 may produce contextual information such as telemetry, defensive responses, system logs, security alerts, or topology data, which can later be used to refine or adapt the simulated activities.

Following execution within the computing environment 130, one or more outputs are transmitted to the remediation action module 140, as indicated by an arrow 135. The remediation action module 140 processes the results of both the initial simulated system attack activities and any adapted simulations. Based on these results, module 140 generates remediation actions, including, for example, recommended configuration modifications, policy adjustments, corrective security controls, compliance-related insights, or prioritized vulnerability-mitigation steps. The remediation action module 140 may also produce machine-readable reports summarizing identified weaknesses, affected assets, and suggested responses.

Overall, the system 100 represents a closed-loop evaluation and remediation pipeline in which simulated attack activities are generated by the AI model 110, deployed into the computing environment 130, and analyzed to produce automated remediation recommendations. The depicted workflow illustrates how the system continuously tests, evaluates, and improves the security posture of an organization by emulating adversarial behaviors in a controlled and non-destructive manner.

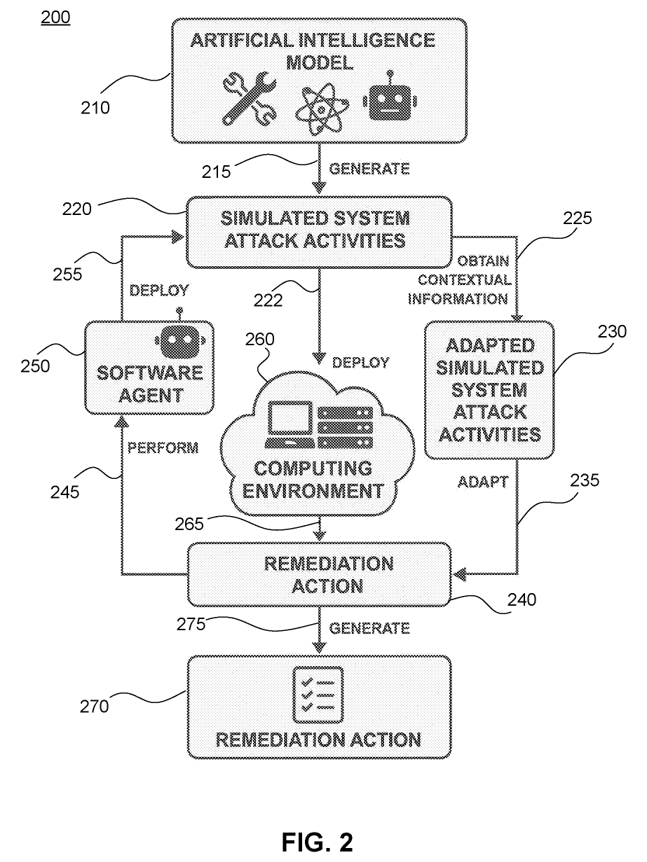

FIG. 2 illustrates an example system 200 for autonomously generating, adapting, deploying, and evaluating simulated system attack activities to identify vulnerabilities and improve the security posture of a computing environment. The system 200 includes an artificial intelligence (AI) model 210, a Simulated Attack Activities Module 220, an Adapted Simulated Attack Activities Module 230, one or more software agents 250, a computing environment 260, and a Remediation Action Module 240 that produces a final remediation action output 270. Together, these components implement an iterative, closed-loop purple-teaming architecture consistent with the autonomous APT-emulation approach described in the accompanying disclosure.

The AI model 210 may include a generative pre-trained model, a large language model (LLM), a reinforcement-learning agent, a hybrid symbolic–neural threat-reasoning system, or any machine-learning framework capable of synthesizing realistic attack sequences. The AI model 210 can generate simulated attack activities based on one or more security frameworks, threat-intelligence feeds, and behaviors previously observed within the environment. The AI model 210 may emulate adversarial tactics, techniques, and procedures of advanced persistent threats and outputs a set of generated attack activities to the Simulated Attack Activities Module 220, as indicated by arrow 215.

The Simulated Attack Activities Module 220 prepares the generated activities for execution. This preparation may include composing sequences of reconnaissance actions, exploitation attempts, privilege-escalation steps, lateral-movement chains, and other behaviors reflecting adversarial intent. Once prepared, the module 220 deploys these simulated activities to the computing environment 260, as indicated by an arrow 222.

As the simulated activities execute, the system obtains contextual information, as shown by arrow 225. This contextual information reflects the computing environment’s responses and may include telemetry, alerts, logs, system states, or other data describing what occurred during the simulations. The contextual information is provided to the Adapted Simulated Attack Activities Module 230.

The Adapted Simulated Attack Activities Module 230 refines the simulated attack behaviors using the contextual information. In some implementations, the module 230 employs retrieval-augmented generation or similar adaptive techniques to tailor subsequent simulations to the environment’s unique characteristics. The module 230 outputs adapted simulated activities, as indicated by arrow 235, which are then redeployed via the Simulated Attack Activities Module 220 to the computing environment 260 using arrow 222. This creates a continuous, iterative feedback loop in which simulated adversarial behaviors evolve based on real-world observations.

The one or more software agents 250 execute the simulated behaviors within the computing environment 260. These agents may include endpoint agents, network agents, or other deployed modules configured to perform controlled, non-destructive simulations that uncover weaknesses without harming production systems. Agents are deployed to carry out the simulated behaviors, as indicated by arrow 255, and execute those behaviors within the computing environment 260, as indicated by arrow 245.

The computing environment 260 may include servers, endpoints, network devices, cloud infrastructure components, and other assets. It is within this environment that both the initial and adapted simulated activities are performed. As these activities proceed, the environment 260 generates the contextual information described above, which is returned to the Adapted Simulated Attack Activities Module 230 via arrow 225, thereby sustaining the iterative adaptation process.

In another implementation, the software agents 250 run on endpoint devices, network infrastructure nodes, cloud workloads, or hybrid IT/OT assets, depending on the environment configuration. The agents 250 perform simulated adversarial behaviors against real or virtualized components while ensuring safe, non-destructive operation. During execution, the computing environment 260 produces contextual information, such as SIEM (Security Information and Event Management) telemetry, EDR/XDR (Endpoint Detection and Response/Extended Detection and Response) alerts, firewall responses, network-traffic patterns, or topology changes, which is supplied to the Adapted Simulated Attack Activities Module 230 via arrow 225.

In some implementations, the Adapted Simulated Attack Activities Module 230 incorporates a retrieval-augmented generation engine that queries threat-intelligence repositories, identifies relevant indicators of attack or compromise, and retrieves up-to-date APT profiles to condition the simulation. Based on these inputs and the received context, the module 230 adjusts the simulated activities by modifying tactics, altering attack paths, or selecting more evasive and environment-specific behaviors. The adapted activities are then redeployed to the computing environment 260 via the Simulated Attack Activities Module 220, as indicated by arrow 222.

Following execution of both initial and adapted activities, results are supplied to the Remediation Action Module 240, as indicated by arrow 265. The Remediation Action Module 240 analyzes observed system responses, defensive control performance, successful and unsuccessful attack stages, and environmental context to generate actionable remediation guidance.

The Remediation Action Module 240 may then produce one or more remediation actions, as shown by an arrow 275, which are provided as the final remediation action output 270. The output 270 may include written recommendations, prioritized guidance, automated configuration adjustments, defensive-control tuning, and compliance-related insights. In some implementations, the output 270 may also include machine-readable reports summarizing attack paths, compliance gaps, estimated breach impacts, and risk scores for affected assets.

Various implementations of the system 200 may incorporate multiple software agents operating in parallel across different segments of the computing environment 260 to emulate distributed or multi-vector attack campaigns. In some implementations, the computing environment 260 includes cloud resources, operational-technology components, or hybrid networks, enabling assessments across traditional IT infrastructure and specialized industrial-control systems.

In further implementations, the AI model 210 and the Adapted Simulated Attack Activities Module 230 may continuously update their behaviors using near-real-time threat-intelligence feeds, allowing simulations to track active threat campaigns. Certain implementations may also support automated or semi-automated deployment of remediation actions through orchestration tools, enabling the system to both detect weaknesses and apply targeted corrective measures.

The structure and sequence shown in FIG. 2 therefore represent a comprehensive, autonomous security testing and remediation system capable of simulating advanced persistent threats, analyzing real-time system responses, adapting simulations based on contextual feedback, and generating meaningful remediation outputs. This iterative, closed-loop approach enables organizations to strengthen their cybersecurity posture in line with continuously evolving adversarial techniques.

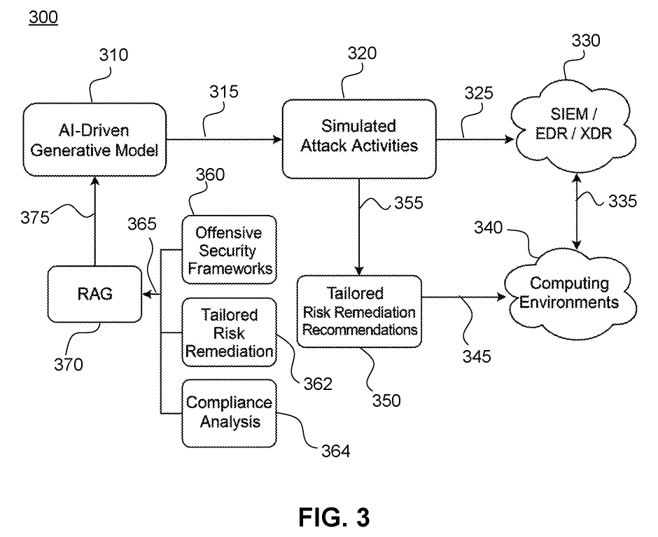

FIG. 3 illustrates an example architecture 300 for autonomously generating simulated adversarial behaviors, analyzing resulting system responses, contextualizing the adversarial simulations using retrieval-augmented generation (RAG), and producing tailored risk-remediation recommendations and compliance insights within a computing environment. The architecture 300 includes an AI-driven generative model 310, a simulated-attack-activity module 320, one or more external security-monitoring systems 330, one or more computing environments 340, a tailored-risk-remediation recommendation engine 350, and a RAG module 370. The system further incorporates a set of offensive-security frameworks 360, tailored risk remediation 362, and compliance-analysis resources 364 for generating context-specific remediation information delivered to the RAG module 370. The following describes each component and the operation of the entire system in substantial detail.

At the left side of FIG. 3, the AI-driven generative model 310 represents one or more artificial-intelligence components configured to generate simulated adversarial behaviors based on cybersecurity frameworks, threat-intelligence data, and environmental context. The AI-driven generative model 310 may include a generative pre-trained model, a large language model (LLM), a reinforcement-learning agent, a hybrid symbolic-neural threat-reasoning system, or any machine-learning framework capable of synthesizing realistic attack sequences. The AI-driven generative model 310 receives contextual parameters, security-control descriptions, vulnerability information, or organizational policies, and uses these inputs to generate multi-stage attack behaviors that mimic real-world adversaries. Arrow 315 from the AI-driven generative model 310 to the simulated attack activities module 320 represents the transmission of the generated adversarial behaviors, including system-interaction commands, exploitation steps, lateral-movement sequences, or privilege-escalation chains.

The simulated-attack-activities module 320 receives the generated attack behaviors and executes or emulates those behaviors within a controlled simulation layer of the computing environment. The module 320 may simulate reconnaissance queries, exploit payload activation, process-injection attempts, credential scraping, privilege-escalation routines, persistence mechanisms, and command-and-control (C2) communications. The outputs of the module 320 include recorded telemetry of system reactions, detection logs, and environmental changes triggered by the simulated attack. As illustrated by arrow 325, the simulated-attack-activities module 320 provides the resulting telemetry, events, and alerts to one or more security-monitoring systems 330, which may include SIEM systems, endpoint-detection platforms (EDR), extended-detection-and-response platforms (XDR), or other defensive-monitoring solutions.

The external monitoring systems 330 are configured to collect, evaluate, and classify the simulated-attack activities. These systems may detect anomalous behaviors, identify incomplete detection rules, or record system-level events relevant to the ongoing adversarial simulation. An arrow 335 from the SIEM/EDR/XDR systems 330 to the computing environments 340 reflects the bi-directional exchange of telemetry and state information. The computing environments 340 may include enterprise networks, cloud infrastructures, operational-technology (OT) systems, industrial-control systems (ICS), virtual machines, containers, or combinations thereof. These computing environments 340 produce runtime telemetry, security logs, resource-usage data, or configuration metadata. An arrow 345 represents the transfer of environmental data from the computing environments 340 to the tailored-risk-remediation recommendations engine 350.

The tailored-risk-remediation recommendations engine 350 processes attack-activity telemetry, environmental context, defensive-system responses, and organizational risk factors to generate tailored risk-remediation recommendations. The engine 350 provides the tailored risk remediation 362, which is configured to evaluate exposure levels, likely attack paths, asset criticality, and potential business impact, and to generate remediation actions such as patching priorities, configuration-hardening recommendations, detection-rule enhancements, segmentation actions, multi-factor authentication configurations, and policy updates. The tailored risk remediation 362 incorporates a compliance-analysis module 364 that analyzes attack results and organizational controls in the context of compliance frameworks such as NIST (National Institute of Standards and Technology Cybersecurity Framework), ISO/IEC 27001 (International Organization for Standardization /International Electronical Commission 27001 information Security Management System), SOC 2 (System and Organization Controls 2, a s security and availability assurance standard published by the American Institute of Certified Public Accountants), HIPAA (Health Insurance Portability and Accountability Act, including its Security Rule and Privacy Rule for safeguarding protected health information), GDPR (General Data Protection Regulation, European Union regulatory Framework governing personal-data protection), and PCI-DSS (Payment Crad industry Data Security Standard, governing the protection of cardholder data), assesses whether a simulated attack would have violated mandated controls, identifies gaps in the compliance posture, and generates compliance-specific remediation instructions. The tailored risk remediation 362 further includes an integration layer 365 connected to offensive-security frameworks 360, including the Penetration Testing Execution Standard (PTES), the OWASP Top Ten, and the MITRE Adversarial Tactics, Techniques, and Common Knowledge (MITRE ATT&CK) framework. These frameworks provide hierarchical structures, enumerated attack techniques, and best-practice guidelines used by the generative model and the remediation modules to classify simulated behaviors and contextualize remediation actions.

Through the integration layer 365, outputs from the offensive-security frameworks 360, the tailored risk remediation 362, and the compliance-analysis module 364 are combined and provided as textual information to the RAG module 370, enabling accurate mapping of simulated attack steps to known TTP categories and ensuring that risk-remediation recommendations correspond to real-world adversarial behaviors.

The RAG module 370 provides additional context to the generative model and the risk-remediation engine. The RAG module 370 retrieves relevant data from knowledge bases, threat-intelligence feeds, vulnerability databases, compliance repositories, code repositories, or historical incident logs. An arrow 375 from the RAG module 370 to the AI-driven generative model 310 represents the injection of retrieved information into the generative process. This feedback loop enables the generative model 310 to refine attack sequences based on the most recent threat intelligence, system conditions, or remediation results. The RAG module 370 may also update the compliance-analysis module 364 with regulatory interpretations or recent compliance changes.

Arrow 355 from the simulated-attack-activities module 320 to the tailored-risk-remediation recommendations engine 350 may reflect the direct transmission of attack-simulation results to the remediation engine. Arrow 345 from the computing environments 340 to the engine 350 represents the environmental and configuration data used for contextualized remediation. The final outputs of the engine 350 include refined remediation recommendations that take into account both the outcomes of the simulated attack and the organization’s specific computing infrastructure.

Through the combined operation of the AI-driven generative model 310, the simulated-attack-activities module 320, the RAG module 370, the offensive-security frameworks 360, and the tailored-risk-remediation recommendations engine 350, the architecture 300 enables an autonomous, adaptive, and context-aware purple-teaming system. The system simulates advanced persistent threat (APT) behaviors, evaluates organizational readiness, identifies detection coverage gaps, performs compliance analysis, and produces personalized risk-remediation actions that improve the organization’s cybersecurity posture.

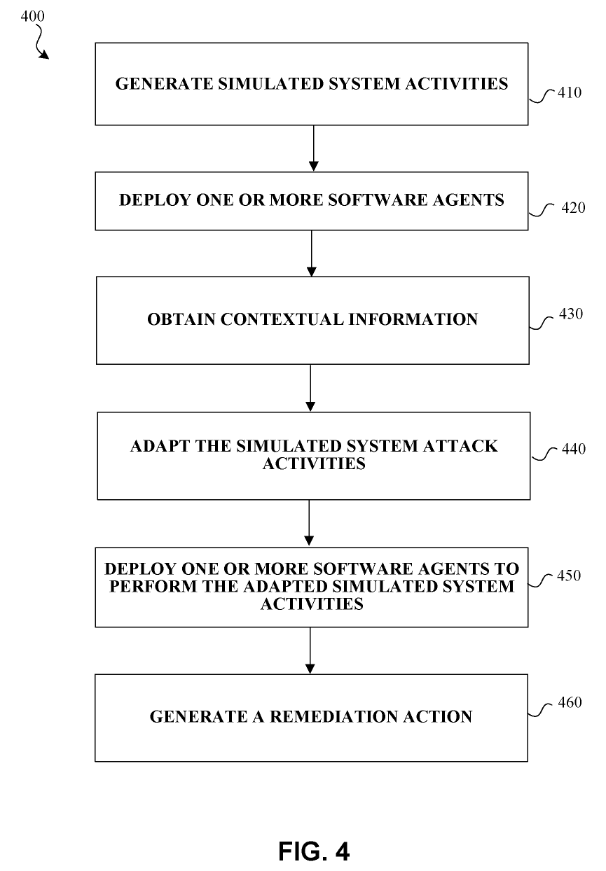

FIG. 4 is a flow diagram illustrating an example method 400 for autonomously simulating system attack activities and generating remediation actions within a computing environment. The method 400 is executed at one or more computing devices that may include an orchestration server, distributed endpoint agents, network agents, memory, and communication interfaces. The operations may be implemented in hardware, software, or a combination of both. The computing devices may be deployed in on-premises environments, cloud infrastructures, or hybrid architectures and may operate within both information technology (IT) and operational technology (OT) systems. The described operations provide a structured approach for generating realistic simulated adversarial behaviors, adapting those behaviors based on environmental context, and producing tailored remediation actions.

At block 410, the method may include generating simulated system attack activities using an artificial intelligence model. The AI model may incorporate one or more offensive-security frameworks—such as the Penetration Testing Execution Standard (PTES), the OWASP Web Top Ten, or the MITRE ATT&CK framework—to produce sequences of tactics, techniques, and procedures representing adversarial behavior.

In some implementations, the model is a generative pre-trained model configured to output multi-stage attack sequences that resemble the behavior of advanced persistent threats (APTs). The simulated activities may include reconnaissance probes, credential-based lateral movement attempts, privilege-escalation logic, or exfiltration-related operations. These simulated activities serve as the basis for an initial attack path against the targeted computing environment.

At block 420, the method may include deploying one or more software agents to perform the simulated system attack activities within the computing environment. The software agents may include endpoint agents running on workstations, servers, containers, or virtual machines, and network agents running on switches, routers, firewalls, or cloud networking components.

The agents may execute non-destructive testing actions designed to mimic real-world adversarial behavior without impacting production systems. For example, an endpoint agent may attempt process injection or privilege elevation without writing malicious payloads, while a network agent may simulate lateral movement by attempting routing or segmentation bypass probes without actually transferring harmful data.

Deployment of the agents enables the system to observe how existing security controls respond to simulated attacks while ensuring operational safety.

At block 430, the method may include obtaining contextual information from the computing environment following execution of the initial simulated activities. The contextual information may be collected from telemetry sources such as SIEM platforms, EDR tools, XDR systems, identity logs, firewall alerts, or system event streams.

This telemetry may reveal whether defensive mechanisms—such as detection rules, heuristics, or anomaly-based controls—triggered alerts, blocked activities, or quarantined processes. In some implementations, contextual data includes updated environment topology information describing system interdependencies, trust boundaries, and network paths.

The collected information provides a real-time snapshot of how the environment reacted to the simulated attack activities and serves as the basis for refining the attack path.

At block 440, the method may include adapting the simulated system attack activities using a retrieval-augmented generation (RAG) technique based on the contextual information. The RAG technique may retrieve relevant threat-intelligence records, including indicators of attack (IoAs), indicators of compromise (IoCs), or profiles of known advanced persistent threats, and use this information to adjust the attack path.

For example, if a lateral-movement technique generated at block 410 triggered a detection event during the first execution, the AI model may retrieve alternate TTPs from external knowledge sources and modify the attack sequence to adopt a more evasive technique. Similarly, privilege escalation attempts may be adjusted to match observed system configurations or vulnerabilities.

The output of this block is an adapted attack path that more accurately reflects adversarial behavior under the specific conditions of the computing environment.

At block 450, the method may include deploying the software agents again to perform the adapted simulated system attack activities. The second (and potentially subsequent) deployments allow the system to validate whether the newly adapted attack path successfully bypasses the defensive controls that blocked earlier attempts.

In some implementations, this process is iterative: after each execution cycle, new contextual information is gathered, the attack path is further refined, and the agents are redeployed until a coverage criterion is satisfied. Examples of coverage criteria include exercising a minimum percentage of MITRE ATT&CK techniques relevant to the environment or validating all reachable assets on a given network segment.

At block 460, the method may include generating a remediation action based on the outcomes of both the initial and adapted system attack activities. The remediation action may take the form of recommended configuration changes for security devices, updates to firewall or identity-management policies, or visibility improvements for cloud infrastructure.

In some implementations, the system generates compliance insights by mapping identified weaknesses to specific regulatory frameworks or industry security standards. Additionally, the system may calculate hypothetical breach costs associated with successful attack paths, producing asset-level risk scores that reflect both impact and likelihood.

The remediation action may be delivered as a human-readable report or a machine-readable artifact suitable for automated enforcement.

In some implementations, the method 400 may be embodied in program instructions stored on one or more non-transitory computer-readable media. When executed by processors of the orchestration server and the distributed agents, the program instructions cause the system to perform the series of operations described above. Through this execution, the system is able to generate simulated adversarial behaviors, adapt those behaviors using retrieval-augmented generation techniques based on contextual information, redeploy revised attack sequences for validation, and ultimately produce remediation insights that are automatically or semi-automatically tailored to the characteristics of the computing environment.

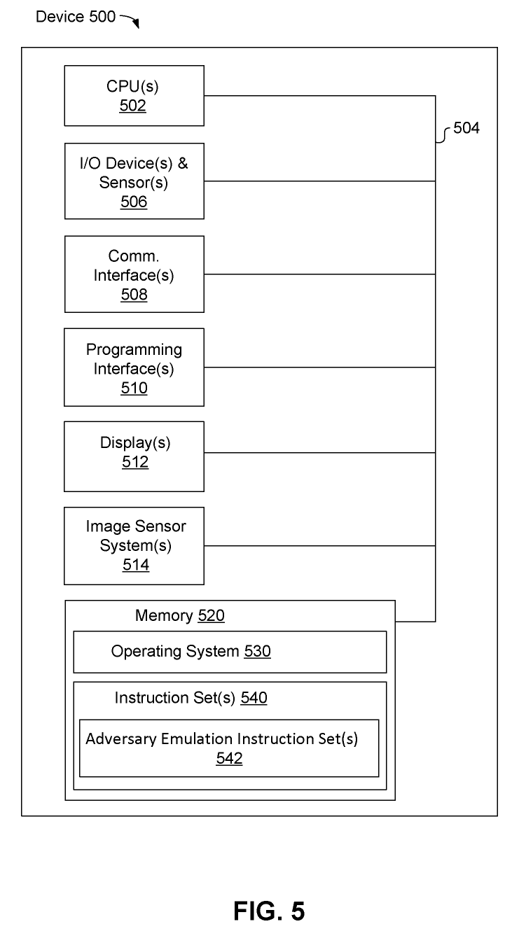

FIG. 5 illustrates an example electronic device 500 configured to execute an autonomous, AI-driven purple teaming platform that simulates advanced persistent threats (APTs) across information technology (IT) and operational technology (OT) environments and generates tailored risk remediation and compliance insights. The device 500 may be implemented as a distributed architecture spanning on-premises infrastructure and cloud services, or as a unified platform deployed within an enterprise network. In various implementations, the device 500 ingests organizational telemetry and security context, selects and evolves attack tactics, techniques, and procedures (TTPs) using generative models, coordinates simulated kill-chain activities through endpoint and network agents, and produces environment-specific remediation guidance and compliance analyses. Contextual information informing these operations may include, for example, asset inventories, network topologies, identity and access configurations, SIEM/EDR/XDR event streams, and threat-intelligence feeds containing indicators of attack (IoAs) and indicators of compromise (IoCs).

The device 500 includes one or more central processing units (CPUs) 502 configured to execute an operating environment and purple-team orchestration logic. The CPUs 502 communicate with subsystems over a system bus 504. A generative AI agent 510 selects, sequences, and adapts TTPs for simulated adversary behavior based on organizational architecture and security posture. A retrieval-augmented generation (RAG) engine 512 interfaces with a threat-intelligence datastore 514 and a security-context graph 516 to ground model outputs in current adversary tradecraft and enterprise-specific conditions. A simulation orchestrator 522 coordinates execution of kill-chain stages, including reconnaissance, initial access, execution, privilege escalation, defense evasion, lateral movement, collection, command-and-control, and exfiltration. One or more endpoint agents 530 and network agents 532 execute emulated actions on target systems and network segments. Telemetry and detections are collected via security integrations 540, which may include interfaces to SIEM, EDR, XDR, and other monitoring platforms to track blue-team responses and enable real-time adaptation of simulated attack paths.

The device 500 may further include a management console 550 for presenting configuration settings, simulation status, and analytic outputs to security operators. A remediation and compliance module 560 generates tailored risk remediation recommendations, maps identified weaknesses to applicable regulatory frameworks, and estimates potential breach costs associated with successfully executed simulated kill chains. A memory 520 stores executable components, including an operating system 580 and an instruction set 590 implementing autonomous purple teaming functionality. The instruction set 590 may include a framework integration module 592 to normalize and apply offensive security guidance (e.g., PTES, OWASP, MITRE ATT&CK) and an environment-mapping module 594 to build and maintain the security-context graph 516 from asset inventories, identity data, cloud control-plane metadata, and observed network flows. One or more communication interfaces 570 support secure connectivity to enterprise resources, cloud services, and third-party threat-intelligence providers. Optional sandboxing or isolation components 574 may be used to constrain and safely instrument simulated actions.

In operation, the device 500 may determine and adapt simulated adversary behavior by comparing organizational context obtained from the security-context graph 516 and streaming telemetry with attack patterns retrieved via the RAG engine 512. For example, the generative AI agent 510 may select initial access vectors based on exposed services and identity posture, evolve lateral movement strategies in response to detections surfaced by SIEM or EDR integrations, or adjust privilege-escalation attempts to avoid controls indicated by XDR analytics. The simulation orchestrator 522 dispatches stage-specific tasks to the endpoint agents 530 and network agents 532, collects outcomes, and feeds observations back to the generative AI agent 510 to refine subsequent steps. In other implementations, the system may prioritize scenarios by industry-relevant threat profiles, generate prescriptive hardening configurations tailored to particular platforms or cloud environments, map findings to compliance obligations, and produce hypothetical incident cost estimates aligned to the executed kill-chain outcomes.

Collectively, the device 500, associated components, and methods provide a unified framework for autonomously emulating advanced adversaries and generating actionable, environment-specific risk remediation. By combining threat-intelligence grounding, contextual environment mapping, adaptive TTP selection, and bidirectional integration with enterprise security tooling, the platform enables realistic, continuously improving APT simulations that enhance both defensive readiness and compliance posture.

In support of these functions, FIG. 5 further illustrates electronic device 500, which provides an exemplary hardware configuration for implementing electronic device 500. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units 502 (e.g., microprocessors, ASICs, FPGAs, GPUs, CPUs, processing cores, and/or the like), one or more input/output (I/O) devices and sensors 506, one or more communication interfaces 508 (e.g., USB, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 510, one or more output device(s) 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 512 include one or more displays configured to present a view of a 3D environment to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 500 includes a single display. In another example, the device 500 includes a display for each eye of the user.

In some implementations, the one or more output device(s) 512 comprise graphical user interfaces and programmatic interfaces configured to present results generated by the autonomous AI-driven purple teaming system. The output device(s) 512 can render, in real time, simulated attack stages and timelines, indicators of attack and indicators of compromise observed during emulations, and tracking of red-team activities and blue-team responses. The output device(s) 512 further present tailored risk remediation recommendations generated by the system, environment- and industry-specific compliance analyses, and hypothetical breach-cost estimations associated with executed kill chains. Outputs may be provided as interactive visualizations, human‑readable summaries, or machine‑readable data structures suitable for downstream processing or archival. In some implementations, the output device(s) 512 additionally generate exportable reports and notifications reflecting the current simulation state, detected vulnerabilities, and prioritized remediation actions.

In some implementations, the one or more image sensor systems 514 are configured to obtain image data that corresponds to at least a portion of a physical environment.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 comprises a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 includes adversary emulation instruction set(s) 542 configured to, upon execution, ingest and interpret endpoint and network agent events, SIEM/EDR/XDR telemetry, and security control response signals within the organization’s IT/OT environment as described herein. The instruction set(s) 540 may be embodied as a single software executable or multiple software executables.

Although the instruction set(s) 540 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the inventio

What is claimed is:

1. A method comprising:
at one or more computing devices:
generating simulated system attack activities using an artificial intelligence model that inputs information from one or more security frameworks;
deploying one or more software agents to perform the simulated system activities within a computing environment;
obtaining contextual information from the computing environment following the deploying of the one or more software agents;
adapting the simulated system attack activities using a retrieval-augmented generation (RAG) technique based on contextual information;
deploying one or more software agents to perform the adapted simulated system activities within the computing environment; and
generating a remediation action based on outcomes of performance of the simulated system activities and the adapted simulated system activities.

2. The method of claim 1, wherein the one or more security frameworks comprise at least one of: Penetration Testing Execution Standard (PTES), Open Worldwide Application Security Project Web Top Ten (OWASP Web Top Ten), and MITRE Adversarial Tactics, Techniques, and Common Knowledge (MITRE ATT&CK).

3. The method of claim 1, wherein the artificial intelligence model comprises a generative pre-trained model configured to generate simulated system attack activities as sequences of attack tactics, techniques, and procedures.

4. The method of claim 1, wherein obtaining the contextual information from the computing environment comprises ingesting telemetry from at least one of: a Security Information and Event Management (SIEM) platform, an Endpoint Detection and Response (EDR) platform, and an Extended Detection and Response (XDR) platform.

5. The method of claim 1, wherein the one or more software agents comprise endpoint agents executing on endpoint devices and network agents executing on network infrastructure devices within the computing environment.

6. The method of claim 1, wherein the computing environment comprises at least one information technology (IT) environment and at least one operational technology (OT) environment.

7. The method of claim 1, wherein adapting the simulated system attack activities using the retrieval-augmented generation technique comprises selecting and modifying attack tactics, techniques, and procedures based on the contextual information to generate an evasive attack path.

8. The method of claim 1, wherein adapting the simulated system attack activities using the retrieval-augmented generation technique comprises:
retrieving, from a threat-intelligence datastore, records describing indicators of attack (IoAs), indicators of compromise (IoCs), and advanced persistent threat (APT) profiles, and
conditioning the simulated system attack activities based on the retrieved records.

9. The method of claim 1, wherein generating the remediation action comprises generating one or more configuration changes for at least one of: a network security device; an endpoint security agent; a cloud infrastructure control; or an identity and access management policy.

10. The method of claim 1, wherein generating the remediation action further comprises mapping identified weaknesses in the computing environment to one or more compliance requirements associated with an industry regulation or security standard and generating compliance insights indicating at least one compliance gap.

11. The method of claim 1, wherein generating the simulated system attack activities comprises generating a sequence of attack stages including reconnaissance, initial access, exploitation, privilege escalation, lateral movement, and data exfiltration.

12. The method of claim 1, wherein obtaining the contextual information from the computing environment comprises monitoring defensive responses of one or more security controls to the simulated system activities, the defensive responses comprising at least one of: an alert, a block action, or a quarantine action.

13. The method of claim 1, further comprising iteratively repeating: obtaining updated contextual information, adapting the simulated system attack activities using the retrieval-augmented generation technique, and deploying the one or more software agents to perform the adapted simulated system activities, until a coverage criterion with respect to assets or attack techniques in the computing environment is satisfied.

14. The method of claim 1, wherein the one or more computing devices comprise an orchestration server configured to control simulation campaigns and a plurality of distributed software agents configured to execute respective portions of the simulated system attack activities.

15. The method of claim 1, further comprising calculating a hypothetical breach cost associated with at least one successfully simulated attack path based on the contextual information and one or more attributes of assets implicated by the simulated system activities.

16. The method of claim 15, further comprising assigning a risk score to assets within the computing environment based on the hypothetical breach cost and one or more likelihood metrics derived from the outcomes of performance of the simulated system activities and the adapted simulated system activities.

17. The method of claim 1, wherein generating the remediation action comprises generating a machine-readable report including: a representation of at least one simulated attack path, associated controls that failed or succeeded during the simulated system activities, and prioritized remediation steps.

18. The method of claim 1, wherein deploying the one or more software agents to perform the simulated system activities within the computing environment is constrained to non-destructive operations that avoid modification or exfiltration of production data.

19. The method of claim 1, wherein obtaining the contextual information from the computing environment comprises constructing or updating a topology model of the computing environment, the topology model representing network segments, assets, and interdependencies between services, and wherein adapting the simulated system attack activities is based at least in part on the topology model.

20. A system for simulating system attack activities and generating remediation actions, the system comprising:
one or more processors; and
one or more non-transitory computer-readable media storing instructions that, when executed by the one or more processors, cause the system to:
generate simulated system attack activities using an artificial intelligence model that inputs information from one or more security frameworks;
deploy one or more software agents to perform the simulated system activities within a computing environment;
obtain contextual information from the computing environment following deployment of the one or more software agents;
adapt the simulated system attack activities using a retrieval-augmented generation technique based on the contextual information;
deploy one or more software agents to perform the adapted simulated system activities within the computing environment; and
generate a remediation action based on outcomes of performance of the simulated system activities and the adapted simulated system activities.
